(19) United States
(12) Patent Application Publication
(10) Pub. No.: US 2014/0241000 A1
(43) Pub. Date: Aug. 28, 2014

(54) Vehicular Lamp

(71) Applicant: Koito Manufacturing Co., Ltd., Shizuoka-shi (JP)

(72) Inventor: Akinori Matsumoto, Shizuoka-shi (JP)

(73) Assignee: Koito Manufacturing Co., Ltd., Shizuoka-shi (JP)

(21) Appl. No.: 14/186,983

(22) Filed: Feb. 21, 2014

(30) Foreign Application Priority Data
Feb. 27, 2013 (JP) 2013-037230

(51) Int. Cl. B60Q 1/00

(52) U.S. Cl. CPC B60Q 1/0041
USPC 362/512; 362/509

(57) ABSTRACT

A vehicular lamp including at least three or more optical systems (10 to 50) that form respective illumination areas (15 to 55) in front of the lamp, thus forming a light distribution pattern in front of the lamp with the bombined illumination areas (15 to 55). The optical axes of the optical systems (10 to 50) are offset from one another in a horizontal direction in the order from the optical system (10) provided at the uppermost position to the optical system (50) provided at the lowermost position such that the illumination area (15) formed by the optical system (10) at the uppermost position is located at one end of the light distribution pattern in the horizontal direction, and the illumination area (55) formed by the optical system (50) at the lowermost position is located at the other end of the light distribution pattern in the horizontal direction.

### BACKGROUND OF THE INVENTION

1. Field of the Invention

The present invention relates to a vehicular lamp that includes a plurality of optical systems arranged in a vertical direction.

2. Description of the Related Art

A vehicular lamp including a plurality of optical systems is known as disclosed in, for example, Japanese Patent Application Laid-Open (Kokai) No. 2003-317513. The vehicular lamp in this Japanese Patent Application Laid-Open (Kokai) No. 2003-317513 forms a desired light distribution pattern by way of overlapping illumination areas formed by the optical (lighting) systems.

Like the vehicular lamp as described in Japanese Patent Application Laid-Open (Kokai) No. 2003-317513, in the case where the optical systems are arranged in a horizontal direction, horizontal positions of the optical axes of the optical systems are generally the same. Therefore, forming a light distribution pattern by overlapping the illumination areas in the horizontal direction does not cause an uncomfortable feeling.

However, in recent years, it has been required that a plurality of optical systems is arranged in a longitudinal direction in view of design requirement. Arranging a plurality of optical systems in the longitudinal direction and overlapping the illumination areas in a horizontal direction causes level differences among the upper sides or lower sides of the illumination areas because the horizontal positions of the optical axes of the optical systems are different from each other. Therefore, the upper side or lower side of the formed light distribution pattern becomes uneven, causing the driver of the vehicle with such optical systems to feel uncomfortable.

### BRIEF SUMMARY OF THE INVENTION

It is, therefore, an object of the present invention to provide a vehicular lamp that includes a plurality of optical systems arranged in a vertical direction and is capable of forming a light distribution pattern that is unlikely to cause an uncomfortable optical feeling.

A vehicular lamp according to the present invention that solves the problems described above includes at least three or more optical systems which are provided at different positions in a vertical direction of the lamp and each of which forms an illumination area in front of the lamp so that the vehicular lamp forms a light distribution pattern in front of the lamp by combining these illumination areas; and in this vehicular lamp, the optical axes of the optical systems are provided to offset from one another in a horizontal direction in the order from the optical system provided at an uppermost position to the optical system provided at a lowermost position such that the illumination area formed by the optical system at the uppermost position is located at one end of the light distribution pattern in the horizontal direction and the illumination area formed by the optical system at the lowermost position is located at the other end of the light distribution pattern in the horizontal direction.

In this vehicular lamp according to the present invention, the optical axes of the optical systems can be parallel to each other as seen from the side of the lamp.

In addition, the vehicular lamp according to the present invention be designed so that the optical axes of the optical systems is turnable in the horizontal direction and they can turn horizontally in synchronization with each other.

In the vehicular lamp according to the present invention, it can be further designed so that the optical axes of the optical systems are capable of turning independently in the horizontal direction, and turning angles of the optical axes are set such that each of the illumination areas moves between (and not beyond) the ends in the horizontal direction of the respective illumination areas that are adjacent to each of the illumination areas.

As seen from the above, the present invention provides a vehicular lamp that includes a plurality of optical systems arranged in a vertical direction and is capable of forming a light distribution pattern that is unlikely to cause an uncomfortable feeling to the driver.

### BRIEF DESCRIPTION OF THE SEVERAL VIEWS OF THE DRAWINGS

FIG. 1(a) is a side sectional view of a vehicular lamp according to one embodiment of the present invention, and FIG. 1(b) is a front view thereof.

FIG. 2 is a top view of the vehicular lamp according to the embodiment of FIG. 1(a).

FIG. 3 is a schematic view of a light distribution pattern formed by the vehicular lamp according to the embodiment of the present invention.

FIG. 4 is a schematic view of another light distribution pattern formed by the vehicular lamp according to another embodiment of the present invention.

FIG. 5 is a front view of a vehicular lamp according to a modification of the present invention.

### DETAILED DESCRIPTION OF THE INVENTION

Hereafter, one embodiment in which a vehicular lamp according to the present invention is applied to a vehicular headlamp will be described in detail with reference to the accompanying drawings.

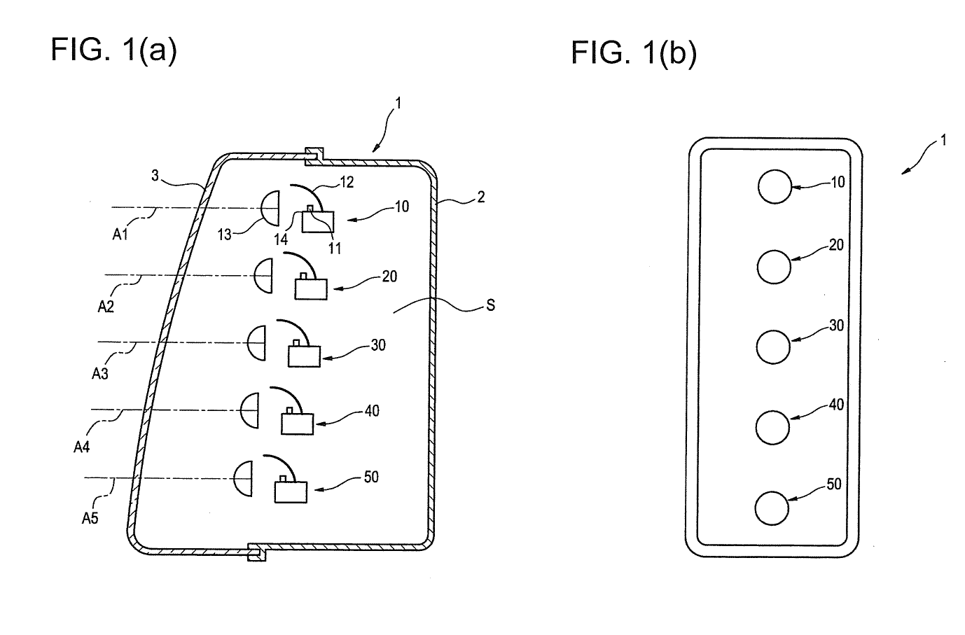

FIG. 1(a) is a side sectional view of a vehicular headlamp 1, and FIG. 1(b) is a front view of the vehicular headlamp 1. As shown in FIG. 1(a), the vehicular headlamp 1 comprises a housing 2 that is open to the front and an outer lens 3 provided in front of the housing 2 so as to cover the opening of the housing 2. The housing 2 and the outer lens 3 form a lamp chamber S inside the vehicular headlamp 1.

A first optical system 10, a second optical system 20, a third optical system 30, a fourth optical system 40, and a fifth optical system 50 are provided in the lamp chamber S. As shown in FIG. 1(b), the first optical system 10 to the fifth optical system 50 are linearly arranged in the order from the top to the bottom in a vertical direction of the headlamp 1. In other words, the first optical system 10 is provided at an uppermost position in the lamp chamber, and the fifth optical system 50 is provided at a lowermost position in the lamp chamber.

The first optical system 10 is comprised of a light source 11 that is formed from an LED, a discharge bulb, etc., a reflector 12 that reflects light from the light source 11 to the front, a projection lens 13 that has an optical axis A1 extending in a front-back direction, and a shade 14 that has a cut line. A part of the direct light from the light source 11 and the light reflected from the reflector 12 is blocked by the shade 14 and projected out through the projection lens 13 to the front of the lamp. Accordingly, the light emitted from the first optical system 10 to the front of the lamp forms a first illumination area 15 (see FIG. 3) that has a cut-off line on its upper side.

Each of the second optical system 20 to the fifth optical system 50 has the same configuration as the first optical system 10, and therefore a detailed description thereof will be omitted. In the following descriptions, respective optical axes of projection lenses of the optical systems 10 to 50 are referred to as optical axes A1 to A5 of the optical systems 10 to 50.

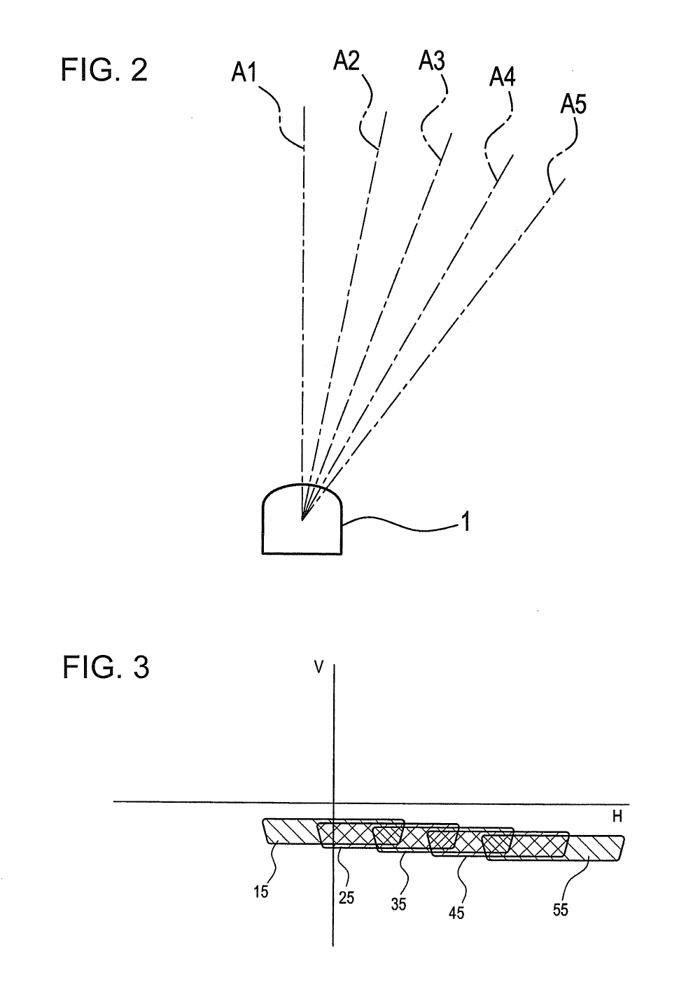

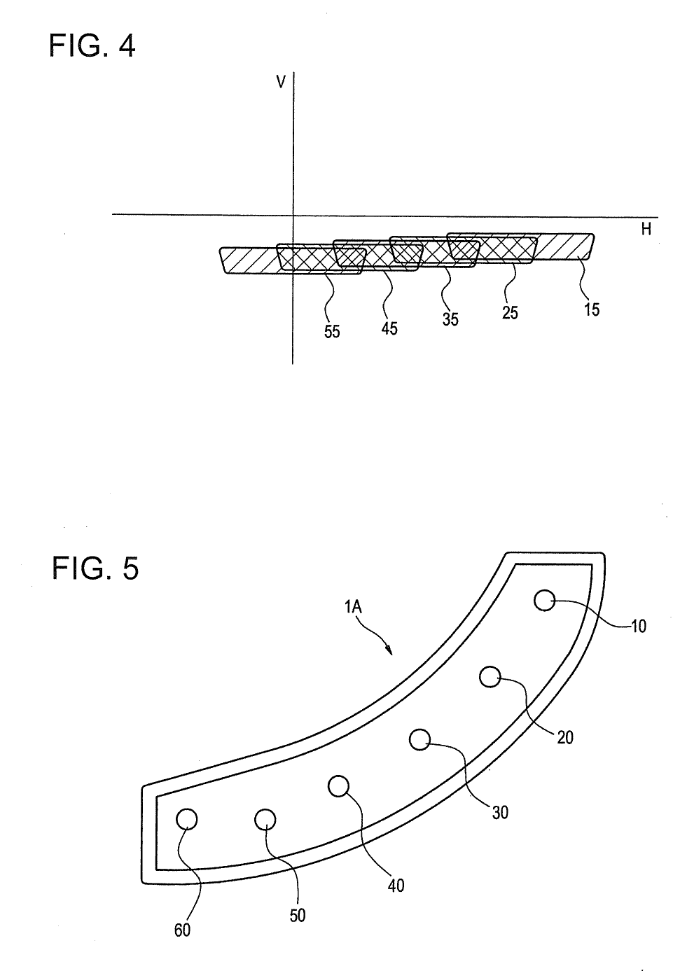

As shown in FIG. 1(a), the optical axes A1 to A5 of the first optical system 10 to the fifth optical system 50 are set so as to be parallel to each other as seen from the side of the lamp. As shown in FIG. 2, the directions of the optical axes A1 to A5 of the first optical system 10 to the fifth optical system 50 are offset in this order in the horizontal direction (see H in FIGS. 3 and 4 as well). In this shown embodiment, the optical axis A1 extends toward the front of the lamp, and the optical axis A2 to the optical axis A5 are offset in this order from the optical axis A1 toward the right when the lamp is seen from the front. FIG. 2 shows the vehicular headlamp 1 as seen from the top.

The vehicular headlamp 1 forms a low-beam distribution pattern (an example of a light distribution pattern) with a wide width in the horizontal direction, as shown in FIG. 3, in front of the lamp by combining the first illumination area 15 to the fifth illumination area 55. FIG. 3 shows a vertical screen provided at a distance of 25 m ahead of the lamp.

The first optical system 10 to the fifth optical system 50 are arranged in the order from the top to the bottom in the vertical direction (see V in FIGS. 3 and 4 as well), and the optical axes of the first optical system 10 to the fifth optical system 50 are set to be parallel to each other as seen from the side.

Therefore, the first illumination area 15 formed by the first optical system 10 is located at the uppermost position, the second illumination area 25 formed by the second optical system 20 is at a position offset downward from the first illumination area 15, the third illumination area 35 formed by the third optical system 30 is at a position offset downward from the second illumination area 25, the fourth illumination area 45 formed by the fourth optical system 40 is at a position offset downward from the third illumination area 35, and the fifth illumination area 55 formed by the fifth optical system 50 is at a position offset downward from the fourth illumination area 45.

In other words, the formation positions of the illumination areas 15 to 55 formed by the optical systems 10 to 50 are offset downward in this order, so that the first illumination area 15 is located at the uppermost position, and the fifth illumination area 55 is located at the lowermost position. This makes vertical differences between the upper sides of adjacent illumination areas, for example, between the upper side of the first illumination area 15 and the upper side of the second illumination area 25 in a vertical direction.

Furthermore, according to the vehicular headlamp 1 of the shown embodiment, the first optical axis A1 of the first optical system 10 to the fifth optical axis A5 of the fifth optical system 50 are offset regularly from one another in the horizontal direction. Therefore, the upper sides of the illumination areas 15 to 55 are offset downward in this order from the left to the right, and thus, the position of the upper side of the light distribution pattern is lowered from the left to the right, whereby the driver of the vehicle with the headlamp 1 is unlikely to feel uncomfortable with the light distribution pattern. On the other hand, in the case where the directions of the optical axes of the optical systems are offset from one another in the horizontal direction at random unlike the shown embodiment, the vertical positions of the upper sides of the illumination areas vary at random, and randomly uneven upper side of the light distribution pattern is formed, making the driver feel uncomfortable.

As described above, according to the vehicular headlamp 1 of the shown embodiment, the directions of the optical axes A1 to A5 of the first optical system 10 to the fifth optical system 50 are offset from one another in the horizontal direction in the order from the first optical system 10 provided at the uppermost position to the fifth optical system 50 provided at the lowermost position such that the first illumination area 15 formed by the first optical system 10 at the uppermost position (refer to vertical line V in FIG. 3) is located at the left end of the light distribution pattern in the horizontal direction (see horizontal line H in FIG. 3), and the fifth illumination area 55 formed by the fifth optical system 50 at the lowermost position is located at the right end of the light distribution pattern in the horizontal direction. Therefore, even in the case where the light distribution pattern with a wide width in the horizontal direction is formed by the plurality of the optical systems arranged in the vertical direction, the differences in the position of the upper side of the light distribution pattern vary regularly, and the driver of the vehicle is unlikely to feel uncomfortable.

Unlike the above-described embodiment, the optical axes A1 to A5 of the optical systems 10 to 50 can be set so as to intersect with each other rather than be parallel to each other to form a light distribution pattern with a flat upper side on the screen.

However, in the case where the optical axes are set in the manner described above, a vertical position of the upper side of the light distribution pattern varies between the area close to a specific point (a screen position, here) and the area remote from the specific point. Therefore, when traveling while illuminating the remote area and the close area, the driver tends to feel uncomfortable with the light distribution pattern. In addition, it is not preferred that the optical axes be set upward with respect to a horizontal surface, because this may give an oncoming vehicle a glare.

Therefore, as described above, preferably, the optical axes A1 to A5 of the optical systems 10 to 50 are set so as to be generally parallel to each other as seen from the side. The term “being generally parallel” used here includes, in addition to the case of being perfectly parallel, a case having error of about ±1 degree.

In addition, unlike the embodiment described above, in the case where a single light distribution pattern is formed by a vehicular headlamp that includes a plurality of optical systems arranged in the horizontal direction, the above-described problem of driver's discomfort does not occur. This is because, in such a vehicular headlamp, in general, the optical axes of the plurality of optical systems are set so as to be parallel to each other, and therefore, the vertical positions of illumination areas formed by the optical systems are not offset from one another, and thus it is unnecessary to align the vertical positions of the illumination areas.

In the case of a vehicle with, for instance, a front-lighting system (AFS) in which the vehicular headlamp 1 emits light in the traveling direction of the vehicle, the optical systems 10 to 50 can be mounted on a common supporting member that is capable of turning in the horizontal direction so that the multiple optical axes A1 to A5 of the optical systems 10 to 50 turn in the horizontal direction. In this structure, the optical axes A1 to A5 turn in synchronization with each other by turning the supporting member in the horizontal direction. Alternatively, the optical systems 10 to 50 can be individually supported so as to be turned in the horizontal direction so that the optical axes A1 to A5 turn in synchronization with each other. Thus, in this structure, the light distribution pattern can be translated in the horizontal direction without changing the shape of the light distribution pattern, and the driver is unlikely to feel uncomfortable with the light distribution pattern.

Alternatively, in the case where the optical systems 10 to 50 are supported such that the optical axes A1 to A5 of the optical systems 10 to 50 are independently turned in the horizontal direction, turning angles of the optical axes A1 to A5 can be set such that each of the illumination areas 15 to 55 is moved (turned) between (and not beyond) the ends in the horizontal direction of the respective illumination areas that are adjacent to each of the illumination areas 15 to 55. In one example, the turning angle of the optical axis A2 of the second optical system 20 can be set such that the illumination area 25 is moved (turned) between (and not beyond) the ends in the horizontal direction of the illumination areas 15, 35 that are adjacent to the illumination area 25. In this structure, the arrangement of the illumination areas 15 to 55 in the horizontal direction is not changed, and the vertical positions of the upper sides of the illumination areas 15 to 55 vary in a regular manner in the light distribution pattern. Therefore, the driver is unlikely to feel uncomfortable with the light distribution pattern.

The vehicular lamp of the present invention is not limited to the above embodiment and can be modified and/or improved in appropriate manners.

For example, the above embodiment is described with respect to an example in which the upper sides of the illumination areas 15 to 55 are offset downward in this order from the left toward the right as seen from the lamp to the front. However, as shown in FIG. 4, the upper sides of the illumination areas 15 to 55 can be arranged so as to be offset downward in this order from the right toward the left. When the illumination area 15 at the uppermost position on the screen is thus arranged so as to be located at the most outer side or right end lateral position, the light can be radiated to a distance in the lateral direction. Therefore, the distant visibility in the lateral direction improves.

The above embodiment is described with respect to an example in which a plurality of optical systems is linearly arranged in a vertical direction. However, the present invention is not limited to this structure. FIG. 5 is a front view of a vehicular headlamp 1A according to a modification of the present invention. As shown in FIG. 5, the multiple optical systems 10 to 50 can be provided such that the horizontal positions of the optical systems 10 to 50 as well as the vertical positions thereof are offset from one another. In this case, because the horizontal positions of the optical systems 10 to 50 are offset from one another, the horizontal positions of the optical axes A1 to A5 are offset from one another. Therefore, even though the optical axes are parallel to each other as seen from the above without changing the directions of the optical axis A1 to A5, the horizontal positions of the illumination areas are offset from one another.

In the above configuration as well, the optical axes A1 to A5 of the first optical system 10 to the fifth optical system 50 extend at different positions in the horizontal direction in the order from the first optical system 10 provided on the upper side to the fifth optical system 50 provided on the lower side such that the first illumination area 15 formed by the first optical system 10 at the uppermost position is located at the left end of the light distribution pattern in the horizontal direction, and the fifth illumination area 55 formed by the fifth optical system 50 at the lowermost position is located at the right end of the light distribution pattern in the horizontal direction. Therefore, a light distribution pattern in which the position of the upper side regularly varies is formed, and the driver is unlikely to feel uncomfortable.

As shown in FIG. 5, the multiple optical systems 50, 60 can be provided at the same position in the vertical direction (or at the same height).

The above embodiments are described with respect to a vehicular headlamp that is capable of forming a low-beam distribution pattern. However, the present invention can also be applied to a vehicular headlamp that is capable of forming a high-beam distribution pattern, a turn-signal lamp, and a fog lamp. In addition, the present embodiment can also be applied to a two-wheel vehicle and a four-wheel vehicle.

1. A vehicular lamp comprising at least three or more optical systems which are provided at different positions in a vertical direction and each of which forms an illumination area in front of the lamp, so that the lamp forms a light distribution pattern in front thereof by combining the illumination areas, wherein
optical axes of the optical systems are offset from one another in a horizontal direction in the order from the optical system provided at an uppermost position to an optical system provided at a lowermost position such that an illumination area formed by the optical system at the uppermost position is located at one end of the light distribution pattern in the horizontal direction and an illumination area formed by the optical system at the lowermost position is located at another end of the light distribution pattern in the horizontal direction.

2. The vehicular lamp according to claim 1, wherein
the optical axes of the optical systems are parallel to each other as seen from a side of the lamp.

3. The vehicular lamp according to claim 1, wherein
the optical axes of the optical systems are turnable in the horizontal direction and in synchronization with each other.

4. The vehicular lamp according to claim 2, wherein
the optical axes of the optical systems are turnable in the horizontal direction and in synchronization with each other.

5. The vehicular lamp according to claim 1, wherein
the optical axes of the optical systems are independently turnable in the horizontal direction, and
turning angles of the optical axes are set such that each of the illumination areas moves between ends in the horizontal direction of the respective illumination areas that are adjacent to the each of the illumination areas.

6. The vehicular lamp according to claim 2, wherein
the optical axes of the optical systems are independently turnable in the horizontal direction, and
turning angles of the optical axes are set such that each of the illumination areas moves between ends in the horizontal direction of the respective illumination areas that are adjacent to the each of the illumination areas.
